(19) United States
(12) Patent Application Publication
(10) Pub. No.: US 2004/0057699 A1
(43) Pub. Date: Mar. 25, 2004

(54) Method for controlling playback operation in an interactive optical disc device

(75) Inventors: Tae Ho Kim, Seoul (KR); Jee Yong Yoo, Seoul (KR); Woo Seong Yoon, Namyangioo-si (KR); Soung Hyun Um, Anyang (KR)

Correspondence Address: JONATHAN Y. KANG, ESQ., LEE & HONG P.C., 11th Floor, 221 N. Figueroa Street, Los Angeles, CA, 90017, US

(73) Assignee: LG Electronics Inc.

(21) Appl. No.: 10/670,966

(22) Filed: Sep. 25, 2003

(30) Foreign Application Priority Data
May 12, 2002 (KR) 10-2002-0077092

(51) Int. Cl. H04N 5/781

(52) U.S. Cl. 386/95; 386/125

(57) ABSTRACT

A method for controlling playback of data recorded on an enhanced navigation medium is provided. The method comprises initializing at least a first playback engine of an enhanced navigation device, when an enhanced navigation mode is selected; entering a first playback state for at least the first playback engine, when an enhanced navigation engine preloads navigation information; and controlling media playback operations, in response to user interaction with a user interface of the enhanced navigation device; wherein the enhanced navigation engine controls a plurality of playback states based on the user interaction with a plurality of user interfaces of the enhanced navigation device.

### CROSS REFERENCE TO RELATED APPLICATION

Pursuant to 35 U.S.C. § 119(a), this application claims the benefit of earlier filing date and right of priority to Korean Patent Application No. 10-2002-77092, filed on Dec. 5, 2002, the content of which is hereby incorporated by reference herein in its entirety.

### BACKGROUND OF THE INVENTION

1. Field of the Invention

The present invention relates to a method for controlling a playback operation of data recorded on an interactive recording medium, and particularly to efficiently control the playback operation for audio/video (A/V) data and contents data recorded on a content disc such as an interactive digital versatile disc (I-DVD), and other contents provided via a content server.

2. Discussion of the Related Art

High-density optical discs (e.g., digital versatile discs (DVDs)) are capable of recording and storing volumes of digital data. The DVDs and certain other recording mediums are capable of permanently recording and storing not only high-quality digital audio data, but also high-quality moving picture data.

A DVD includes a navigation data recording area for recording navigation data needed for controlling a playback operation for the moving picture data, and a data stream recording area for recording a digital data stream such as moving picture data. A typical DVD player first reads the navigation data recorded on the navigation data recording area if the DVD is seated in the player, stores the read navigation data in a memory provided in the player, and reads and reproduces the moving picture data recorded on the data stream recording area using the navigation data.

The DVD player reproduces the moving picture data recorded on the DVD, such that a user can reproduce and view high-quality moving picture recorded on the DVD. Detailed information associated with audio/video (A/V) data read and reproduced from the DVD, in the form of a file written in a hypertext markup language (HTML), can be recorded on the DVD.

Research on an interactive digital versatile disc (I-DVD or an Enhanced digital versatile disc (EDVD)) being read and reproduced through a user interface is ongoing. I-DVDs make it possible for data items of various contents associated with the A/V data recorded on the I-DVD to be easily retrieved from other content sources.

A method for receiving content data from a content provider connected to the Internet while reproducing A/V data and content data recorded on the I-DVD is being developed. A method for effectively controlling playback operation of the A/V data and content data in response to a user's request is needed.

### SUMMARY OF THE INVENTION

A method for controlling a playback operation in an enhanced navigation media player device, in accordance with one or more embodiments I provided. The method comprises defining a plurality of operating states based on coexisting operation modes of the enhanced navigation media player device, wherein in a first operation mode the device is configured to reproduce audio/video (A/V) data recorded on an enhanced navigation medium and in a second operation mode the device is configured to process additional data recorded on an enhanced navigation medium or provided from a remote content provider; and operating the device in at least one of the plurality of operating states, in response to user interfacing with the device to select said at least one of the plurality of operating states.

In one embodiments, the plurality of operating states comprise at least one of N operating states based on said first and second operational modes. The first operational mode has X playback states associated with reproducing A/V data recorded on the enhanced navigation medium. The second operational mode has Y operation states associated with processing additional data recorded on an enhanced navigation medium or provided by the remote content provider, wherein N=X×Y.

In certain embodiments, the first operational mode comprises at least one of play, still and stop states associated with reproduction of the A/V data. The second operational mode comprises at least one of play, idle, and stop states associated with processing of the additional data. If the first operational mode is in a play state and the second operational mode is in a play state, then the device plays back A/V data from the enhanced navigation medium and the device displays additional data received from the enhanced navigation medium or the remote content provider in association with the A/V data.

If the first operational mode is in a still state and the second operational mode is in a play state, then the device temporarily discontinues playing back A/V data and the device displays a still picture of a last A/V data frame reproduced along with additional data received from the enhanced navigation medium or the remote content provider in association with the A/V data. Otherwise, if the first operational mode is in a stop state and the second operational mode is in a play state, then the device discontinues playing back A/V data and the device displays additional data received from the enhanced navigation medium or the remote content provider in association with the A/V data.

In one or more embodiments, the device displays the A/V data in full screen mode and no additional data is displayed. If the first operational mode is in a play state and the second operational mode is in an idle state, then the device plays back the A/V data and the device temporarily discontinues receiving additional data from the enhanced navigation medium or the remote content provider in association with the A/V data.

If the first operational mode is in a play state and the second operational mode is in an idle state, then the device plays back the A/V data and the device continues receiving additional data from the enhanced navigation medium or the remote content provider in association with the A/V data, and the device discontinues displaying the additional data. In one embodiment, the device plays back A/V data in full screen mode.

If the first operational mode is in a still state and the second operational mode is in an idle state, then the device temporarily discontinues playing back the A/V data and the device temporarily discontinues receiving additional data from the enhanced navigation medium or the remote content provider in association with the A/V data, such that the devise displays a still image of the last A/V data displayed.

If the first operational mode is in a stop state and the second operational mode is in an idle state, then the device discontinues playing back the A/V data and the device temporarily discontinues receiving additional data from the enhanced navigation medium or the remote content provider in association with the A/V data.

In certain embodiments, if the first operational mode is in a play state and the second operational mode is in a stop state, then the device plays back the A/V data and the device discontinues receiving additional data from the enhanced navigation medium or the remote content provider in association with the A/V data, wherein the device plays back the A/V data in full screen mode.

If the first operational mode is in a still state and the second operational mode is in a stop state, then the device temporarily discontinues playing back the A/V data and the device discontinues receiving additional data from the enhanced navigation medium or the remote content provider in association with the A/V data.

If the first operational mode is in a stop state and the second operational mode is in a stop state, then the device discontinues playing back the A/V data and the device discontinues receiving additional data from the enhanced navigation medium or the remote content provider in association with the A/V data.

In accordance with one embodiment, an enhanced navigation media player device comprises a playback engine; and an enhanced navigation engine, wherein a plurality of operating states are defined based on coexisting operation modes of the playback engine and the enhanced navigation engine, wherein in response to user interaction, in a first operation mode the playback engine reproduces audio/video (A/V) data recorded on an enhanced navigation medium and in a second operation mode the enhance navigation engine processes additional data recorded in an enhanced navigation medium or provided from a remote content provider.

In some embodiments, the plurality of operating states comprise at least one of N operating states based on said first and second operational modes associated with said playback and enhanced navigation engines, respectively. The first operational mode the playback engine has X playback states associated with reproducing A/V data recorded on the enhanced navigation medium. In the second operational mode the enhance navigation engine has Y operation states associated with processing additional data recorded the enhanced navigation medium or provided by the remote content provider.

The first operational mode comprises at least one of play, still and stop states associated with reproduction of the A/V data. The second operational mode comprises at least one of play, idle, and stop states associated with processing of the additional data.

In another embodiment, a method for controlling playback of data recorded on an enhanced navigation medium, the method comprising initializing at least a first playback engine of an enhanced navigation device, when an enhanced navigation mode is selected; entering a first playback state for at least the first playback engine, when an enhanced navigation engine preloads navigation information; and controlling media playback operations, in response to user interaction with a user interface of the enhanced navigation device; wherein the enhanced navigation engine controls a plurality of playback states based on the user interaction with a plurality of user interfaces of the enhanced navigation device, wherein the first playback state is a stop state.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of an interactive optical disc device to which a playback control method in accordance with one embodiment of the present invention is applied;

FIG. 2 illustrates a display screen for video data and content data respectively reproduced and outputted by the interactive optical disc device in accordance with one or more embodiments; and

FIGS. 3 and 4 are exemplary tables illustrating operating states defined and controlled by the playback control method of the interactive optical disc device of the present invention.

### DESCRIPTION OF THE PREFERRED EMBODIMENTS

In accordance with one embodiment of the invention, a method for controlling playback of data recorded on an enhanced navigation medium is provided. The method comprises initializing at least a first playback engine of an enhanced navigation device, when an enhanced navigation mode is selected. Then a first playback state is entered for at least the first playback engine, while an enhanced navigation engine preloads navigation information.

Media playback operations are controlled, in response to user interaction with a user interface of the enhanced navigation device. Accordingly, the enhanced navigation engine controls a plurality of playback states based on the user interaction with a plurality of user interfaces of the enhanced navigation device. In certain embodiments, one of playback states is a stop state.

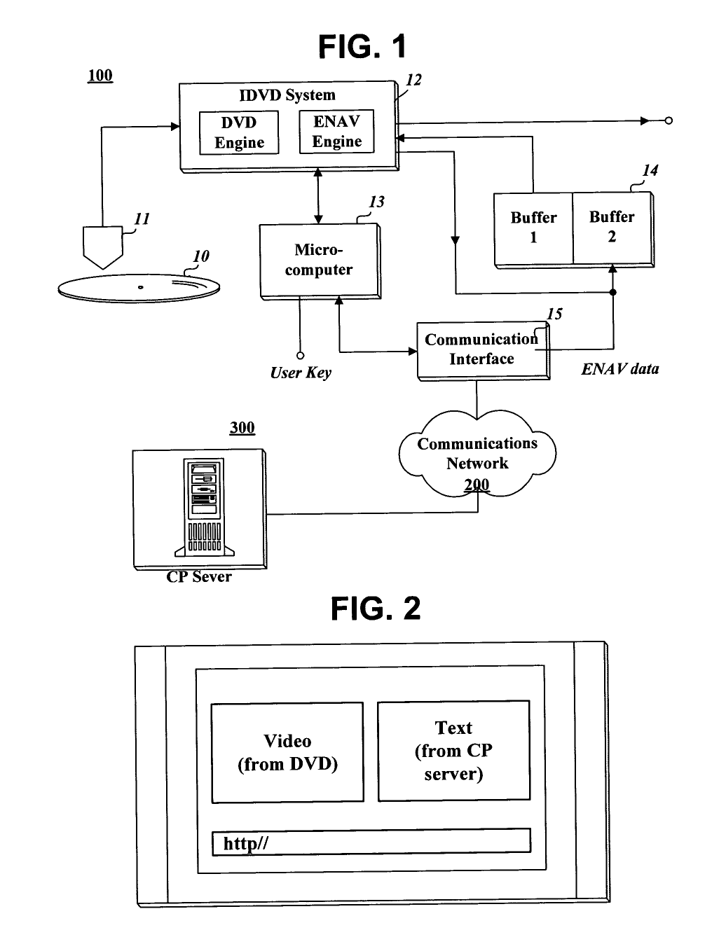

Referring to FIG. 1, in accordance with one or more embodiments of the invention, an interactive optical disc or enhanced navigation device (e.g., I-DVD or ENAV) player 100 comprises an optical pickup 11, an I-DVD system 12, a microcomputer 13, a buffer memory 14, and an interface 15. The I-DVD player 100 is connected to a content server 30 through the interface 15.

Further, the I-DVD system 12 comprises a DVD engine for reproducing and outputting audio/video (A/V) data read from the I-DVD 10, and an ENAV engine or enhanced navigation engine for reproducing and outputting content data provided from the content server 30 and content data read from the I-DVD 10. This invention in accordance with one or more embodiments is described as applicable to an I-DVD or ENAV disc and player. This application is, however, by way of example. It should be understood that other embodiments of the invention may be applicable to any type of recording medium or player.

The I-DVD system 12 performs a synchronization operation for the A/V data and contents data read from the I-DVD 10, and reproduces and outputs the synchronized A/V data and contents data. The interface 15 is connected to the content server 300 through communications network 200, such as the Internet or Intranet, by an interaction of the microcomputer 13 and the ENAV engine embedded in the I-DVD system 12.

The buffer memory 14 downloads various content data provided from the CONTENT server 300, and various ENAV content data associated with the video data read from the I-DVD 10 and temporarily stores the downloaded data. The buffer memory 14 can be physically or logically classified into a first buffer (buffer 1) and a second buffer (buffer 2).

The ENAV engine of the I-DVD system 12 performs a synchronization operation for the A/V data and ENAV contents data read from the I-DVD 10 to output the synchronized data, or performs the synchronization operation for the A/V data and another ENAV content data provided form the CONTENT server 300 to output the synchronized data.

Referring to FIG. 2, a user using the I-DVD player 100 can view a screen of the video data and ENAV content data read from the I-DVD 10. Alternatively other ENAV content data provided from the content server 300 may be also displayed. The user can access a desired web site, for example, by way of a hyper link. A browser software may be also incorporated in one or more embodiments.

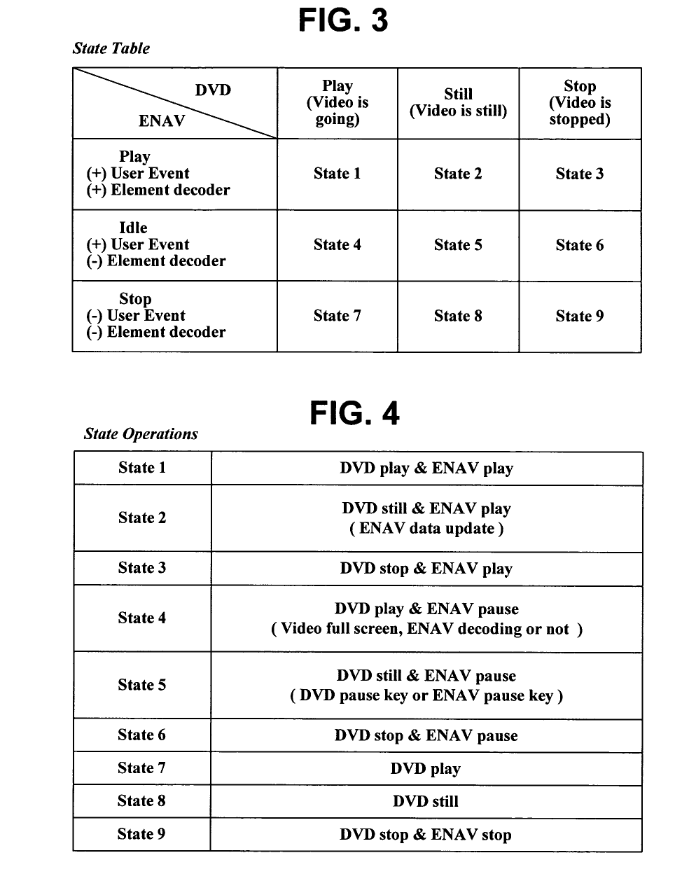

Referring to FIGS. 3 and 4 are exemplary tables illustrating operating states defined and controlled by the playback control method of the interactive optical disc device, in accordance with one embodiment. For example, in the I-DVD player, operating states to be controlled in response to the user's request are classified into 9 operating states (States 1˜9). Such operating states, for example, comprise play, still and stop modes associated with the DVD engine and play, idle and stop modes associated with the ENAV engine.

Referring to FIG. 4, a first operating state (State 1) can be defined as a state where the video data read from the I-DVD is reproduced and outputted by the DVD engine, and simultaneously the ENAV contents data read from the I-DVD or another ENAV content data read from the content server is reproduced and outputted by the ENAV engine.

A second operating state (State 2) can be defined as a state where a play operation for video data read from the I-DVD by the DVD engine is temporarily stopped so that a still picture is outputted and displayed, and simultaneously ENAV content data is reproduced and outputted by the ENAV engine.

For example, after the user inputs uniform resource locator (URL) information of a specified web site after a connection between the web site and the I-DVD player is accomplished, the DVD engine performs a still operation for repeatedly outputting a frame picture being reproduced as a still picture. The ENAV engine performs a connection between a corresponding web site and the I-DVD player, downloads new ENAV contents data from the web site, and performs a play operation for reproducing and outputting the new ENAV content data. At this time, the still operation of the DVD engine can be released automatically or in response to the user's key input.

A third operating state (State 3) can be defined as a state where a play operation for the video data read from the I-DVD by the DVD engine is completely stopped, and simultaneously the ENAV contents data read from the I-DVD is reproduced and outputted by the ENAV engine. In one embodiment, the ENAV content data can be advertisement content, for example.

A fourth operating state (State 4) can be defined as a state where the video data read from the I-DVD is reproduced and outputted by the DVD engine, and simultaneously the user's key input for the ENAV contents data is monitored in an idle operating state. For example, the ENAV engine may not decode new ENAV content data, and may monitor user's key input in a pause state. The video data reproduced and outputted by the DVD engine can be enlarged and displayed in full screen, since no other content is being displayed.

Moreover, where the video data associated with the ENAV content data must be outputted and displayed in a synchronized state, a decoding operation for the ENAV content data is continuously performed. During the decoding process, the ENAV content data is not displayed. On the other hand, if the video data associated with the ENAV contents data does not need to be outputted and displayed in a synchronized state, the decoding operation for the ENAV contents data is not performed.

A fifth operating state (State 5) can be defined as a state where a play operation for the video data read from the I-DVD by the DVD engine is temporarily stopped, a still picture is outputted and displayed, and simultaneously the user's key input for the ENAV contents data is monitored in the idle operating state.

For example, a user may temporarily stop the play operation for the video data or select a pause key for temporarily stopping the play operation for the ENAV content data, while a play operation for the video data and a play operation for the ENAV contents data are associated. In one embodiment, the data items are reproduced and outputted in a synchronized state and the DVD engine performs a still operation for continuously outputting a frame picture being reproduced as a still picture. At this time, the ENAV engine continuously outputs the ENAV content data being reproduced and outputted as the still picture, or temporarily stops download and web-site search operations.

A sixth operating state (State 6) can be defined as a state where the play operation for the video data read from the I-DVD by the DVD engine is completely stopped and simultaneously the play operation for the ENAV content data is temporarily stopped.

A seventh operating state (State 7) can be defined as a state where the video data read from the I-DVD is reproduced and outputted by the DVD engine, and simultaneously an operation of the ENAV engine is completely stopped.

An eighth operating state can be defined as a state where a play operation for the video data read from the I-DVD by the DVD engine is temporarily stopped, a still picture is continuously outputted and displayed, and simultaneously the ENAV engine is completely stopped.

A ninth operating state can be defined as a state where a play operation for the video data read from the I-DVD by the DVD engine is completely stopped, and simultaneously an operation of the ENAV engine is completely stopped. For example, when a system power of the I-DVD player is in an ON state, the ninth operating state corresponds to a system initial booting operation or an optical disc loading operation.

Thus, the I-DVD player can refer to the above-defined nine operating states, and effectively perform a playback control operation for different types of source data items.

It should be understood that the programs, modules, processes, methods, and the like, described herein are but an exemplary implementation and are not related, or limited, to any particular computer, apparatus, or computer programming language. Rather, various types of general-purpose computing machines or devices may be used with logic code implemented in accordance with the teachings provided, herein.

Further, the order in which the steps of the present method are performed is purely illustrative in nature. In fact, the steps can be performed in any order or in parallel, unless indicated otherwise by the present disclosure. The method of the present invention may be performed in either hardware, software, or any combination thereof, as those terms are currently known in the art.

In particular, the present method may be carried out by software, firmware, or macrocode operating on a computer or computers of any type. Additionally, software embodying the present invention may comprise computer instructions in any medium (e.g., ROM, RAM, magnetic media, punched tape or card, compact disk (CD), DVD, etc.).

Furthermore, such software may also be in the form of a computer signal embodied in a carrier wave, or accessible through Web pages provided on computers connected to the Internet. Accordingly, the present invention is not limited to any particular platform, unless specifically stated otherwise in the present disclosure.

As such, a method for controlling a playback operation in an interactive optical disc device, which can discriminatively define a plurality of operating states on the basis of relations among operating modes is provided. The present invention has been described above with reference to preferred embodiments. However, those skilled in the art will recognize that changes and modifications may be made in these preferred embodiments without departing from the scope of the present invention.

The embodiments described above are to be considered in all aspects as illustrative only and not restrictive in any manner. Thus, other exemplary embodiments, system architectures, platforms, and implementations that can support various aspects of the invention may be utilized without departing from the essential characteristics described herein.

These and various other adaptations and combinations of features of the embodiments disclosed are within the scope of the invention. The invention is defined by the claims and their full scope of equivalents.

What is claimed is:

1. A method for controlling a playback operation in an enhanced navigation media player device, the method comprising:
defining a plurality of operating states based on coexisting operation modes of the enhanced navigation media player device, wherein in a first operation mode the device is configured to reproduce audio/video (A/V) data recorded on an enhanced navigation medium and in a second operation mode the device is configured to process additional data recorded on an enhanced navigation medium or provided from a remote content provider; and
operating the device in at least one of the plurality of operating states, in response to user interfacing with the device to select said at least one of the plurality of operating states.

2. The method of claim 1, wherein the plurality of operating states comprise at least one of N operating states based on said first and second operational modes.

3. The method of claim 2, wherein the first operational mode has X playback states associated with reproducing A/V data recorded on the enhanced navigation medium.

4. The method of claim 3, wherein the second operational mode has Y operation states associated with processing additional data data recorded on an enhanced navigation medium or provided by the remote content provider.

5. The method of claim 4, wherein N=X×Y.

6. The method of claim 3, wherein the first operational mode comprises at least one of play, still and stop playback states associated with reproduction of the A/V data.

7. The method of claim 4, wherein the second operational mode comprises at least one of play, idle, and stop display states associated with processing of the additional data.

8. The method of claim 1, wherein if the first operational mode is in a play state and the second operational mode is in a play state, then the device plays back A/V data from the enhanced navigation medium and the device displays additional data received from the enhanced navigation medium or the remote content provider in association with the A/V data.

9. The method of claim 1, wherein if the first operational mode is in a still state and the second operational mode is in a play state, then the device temporarily discontinues playing back A/V data and the device displays a still picture of a last A/V data frame reproduced along with additional data received from the enhanced navigation medium or the remote content provider in association with the A/V data.

10. The method of claim 1, wherein if the first operational mode is in a stop state and the second operational mode is in a play state, then the device discontinues playing back A/V data and the device displays additional data received from the enhanced navigation medium or the remote content provider in association with the A/V data.

11. The method of claim 10, wherein the device displays the additional data in full screen mode and no A/V data is displayed.

12. The method of claim 1, wherein if the first operational mode is in a play state and the second operational mode is in an idle state, then the device plays back the A/V data and the device temporarily discontinues receiving additional data from the enhanced navigation medium or the remote content provider in association with the A/V data.

13. The method of claim 1, wherein if the first operational mode is in a play state and the second operational mode is in an idle state, then the device plays back the A/V data and the device continues receiving additional data from the enhanced navigation medium or the remote content provider in association with the A/V data, and the device discontinues displaying the additional data.

14. The method of claim 12, wherein the device plays back A/V data in full screen mode.

15. The method of claim 1, wherein if the first operational mode is in a still state and the second operational mode is in an idle state, then the device temporarily discontinues playing back the A/V data and the device temporarily discontinues receiving additional data from the enhanced navigation medium or the remote content provider in association with the A/V data.

16. The method of claim 15, wherein the devise displays a still image of the last A/V data displayed.

17. The method of claim 1, wherein if the first operational mode is in a stop state and the second operational mode is in an idle state, then the device discontinues playing back the A/V data and the device temporarily discontinues receiving additional data from the enhanced navigation medium or the remote content provider in association with the A/V data.

18. The method of claim 1, wherein if the first operational mode is in a play state and the second operational mode is in a stop state, then the device plays back the A/V data and the device discontinues receiving additional data from the enhanced navigation medium or the remote content provider in association with the A/V data.

19. The method of claim 18, wherein the device plays back the A/V data in full screen mode.

20. The method of claim 1, wherein if the first operational mode is in a pause state and the second operational mode is in a stop state, then the device temporarily discontinues playing back the A/V data and the device discontinues receiving additional data from the enhanced navigation medium or the remote content provider in association with the A/V data.

21. The method of claim 1, wherein if the first operational mode is in a stop state and the second operational mode is in a stop state, then the device discontinues playing back the A/V data and the device discontinues receiving additional data from the enhanced navigation medium or the remote content provider in association with the A/V data.

22. An enhanced navigation media player device comprising:
a playback engine; and
an enhanced navigation engine,
wherein a plurality of operating states are defined based on coexisting operation modes of the playback engine and the enhanced navigation engine, wherein in response to user interaction, in a first operation mode the playback engine reproduces audio/video (A/V) data recorded on an enhanced navigation medium and in a second operation mode the enhance navigation engine processes additional data readout from the enhanced navigation medium or downloaded from a remote content provider.

23. The player of claim 22, wherein the plurality of operating states comprise at least one of N operating states based on said first and second operational modes associated with said playback and enhanced navigation engines, respectively.

24. The player of claim 23, wherein in the first operational mode the playback engine has X playback states associated with reproducing A/V data recorded on the enhanced navigation medium.

25. The player of claim 24, wherein in the second operational mode the enhance navigation engine has Y operation states associated with processing additional data readout from the enhanced navigation medium or downloaded from the remote content provider.

26. The player of claim 25, wherein N=X×Y.

27. The method of claim 24, wherein the first operational mode comprises at least one of play, still and stop playback states associated with reproduction of the A/V data.

28. The player of claim 25, wherein the second operational mode comprises at least one of play, idle, and stop display states associated with processing of the additional data.

29. A method for controlling playback of data recorded on an enhanced navigation medium, the method comprising:
initializing at least a first playback engine of an enhanced navigation device, when an enhanced navigation mode is selected;
entering a first playback state for at least the first playback engine, when an enhanced navigation engine preloads navigation information; and
controlling media playback operations, in response to user interaction with a user interface of the enhanced navigation device;
wherein the enhanced navigation engine controls a plurality of playback states based on the user interaction with a plurality of user interfaces of the enhanced navigation device.

30. The method of claim 29, wherein the first playback state is a stop state.
